(19) United States
(12) Patent Application Publication
(10) Pub. No.: US 2018/0283952 A1
(43) Pub. Date: Oct. 4, 2018

(54) POLARIZING AXIS DETECTION DEVICE, POLARIZING AXIS DETECTION METHOD, DISPLAY DEVICE PRODUCING METHOD, AND DISPLAY DEVICE PRODUCED THEREBY

(71) Applicant: SHARP KABUSHIKI KAISHA, Sakai City, Osaka (JP)

(72) Inventors: YUHJI TANIGUCHI, Sakai City (JP); MASATAKA OHYAMA, Sakai City (JP); KATSUHIRO YAMAGUCHI, Sakai City (JP)

(21) Appl. No.: 15/765,819

(22) PCT Filed: Oct. 4, 2016
(86) PCT No.: PCT/JP2016/079468

§ 371 Date: Apr. 4, 2018

(30) Foreign Application Priority Data
Oct. 8, 2015 (JP) 2015-200270

(51) Int. Cl. G01J 4/04

(52) U.S. Cl. CPC G01J 4/04; G02F 1/133528

(57) ABSTRACT

A polarizing axis detection device includes: an irradiation head 12 that emits sensor light; a stage 11 on which a polarizing plate is mounted and rotated; a light receiving head 13 that receives sensor light through the polarizing plate, and outputs a signal according to the amount of light received; and an arithmetic circuit 15 that detects orientation of a polarizing axis of the polarizing plate based on the output signal, wherein reference data based on an output signal from the light receiving head 13 when a polarizing plate is arranged such that a polarizing axis thereof is directed in a desired direction are stored preliminarily in a storage part, and sensor light is projected to a polarizing plate on the rotating stage, and the arithmetic circuit 15 detects orientation of a polarizing axis of the polarizing plate, based on a signal output from the light receiving part and the reference data.

### TECHNICAL FIELD

The present invention relates to a polarizing axis detection device used for detecting a polarizing axis of a polarizing plate used in a display device, a method for detecting a polarizing axis of a polarizing plate by using this polarizing axis detection device, a method for producing a display device by using a polarizing plate whose polarizing axis is detected, and a display device produced by this method.

### BACKGROUND ART

For a display device having a polarizing plate, such as a liquid crystal display device or an organic electroluminescence (EL) display device, an issue to be solved is to align a panel and a polarizing plate with high accuracy when the polarizing plate is attached to the panel in the process for producing the display device. Particularly when the aligning operation is performed by rotating the polarizing plate within a plane parallel with the surface of the panel so that the orientation of the polarizing axis should coincide with a predetermined direction, highly accurate control is required.

Conventionally, the position of the polarizing plate is controlled by recognizing an outer shape (edge) or an entirety of the polarizing plate based on an image picked up by a camera, or the like. In recent years, however, as higher image definition is demanded regarding the image quality, an attachment control operation is required to be done with such high accuracy that cannot be achieved by the above-described conventional method. In addition, panels having display surfaces in a variety of shapes other than a rectangular shape, wearable terminals having compact display surfaces, and the like appear, which makes it more difficult to perform the operation of controlling the position of the polarizing plate. For example, in a case of a watch-type terminal in which a liquid crystal panel is used, if the display surface is round, a round polarizing plate is used. In this case, it is difficult to determine the angle at which the polarizing plate is attached (it is difficult to control the orientation of the polarizing axis), by the method of recognizing the outer shape of the polarizing plate.

As another method, the following method is disclosed in JP-A-2013-83784, for example; a pair of polarization films for a front surface and a back surface of a liquid crystal panel are arranged in front of a light source, the amount of transmitted light is measured in a state in which one of the polarization films is fixed and the other polarization film is rotated, and a mark for alignment is formed at the point in time when the amount of transmitted light is maximized or minimized. In the case of the foregoing method disclosed in this publication, however, a pair of polarization films have to be rotated relatively.

### PRIOR ART DOCUMENT

### Patent Document

### Patent Document 1: JP-A-2013-83784

### SUMMARY OF THE INVENTION

### Problem to be Solved by the Invention

In light of the above-described problems, it is an object of the present invention to provide a technique that allows a polarizing axis of a polarizing plate to be easily detected, irrespective of the shape of the polarizing plate, even in a case of a round polarizing plate or a deformed polarizing plate (a polarizing plate having a shape other than a round shape or a rectangular shape).

### Means to Solve the Problem

To achieve the above-described object, a polarizing axis detection device according to the present invention is characterized by including:

an irradiation part configured to emit sensor light;

a stage on which a polarizing plate is mounted and that rotates;

a light receiving part configured to receive sensor light that has been transmitted through the polarizing plate on the stage, and outputs a signal according to amount of light received; and

an arithmetic part configured to detect orientation of a polarizing axis of the polarizing plate based on the output signal from the light receiving part,

wherein reference data based on an output signal from the light receiving part in a state in which a polarizing plate is arranged with a polarizing axis of the polarizing plate being directed in a desired direction are stored preliminarily in a storage part accessible form the arithmetic part, and

sensor light is projected to a polarizing plate on the stage while the stage is being rotated, and the arithmetic part detects orientation of a polarizing axis of the polarizing plate on the stage, based on a signal output from the light receiving part and the reference data stored in the storage part.

### Effect of the Invention

The present invention makes it possible to easily detect a polarizing axis of a polarizing plate, irrespective of the shape of the polarizing plate, even in a case of a round polarizing plate or a deformed polarizing plate.

### BRIEF DESCRIPTION OF DRAWINGS

FIG. 1 is a schematic diagram illustrating a schematic configuration of a polarizing axis detection device according to Embodiment 1.

FIG. 2 is a waveform diagram illustrating an exemplary reference waveform.

FIG. 3 is a waveform diagram illustrating an exemplary waveform measured from a polarizing plate as an object of detection.

FIG. 4 is a waveform diagram illustrating phase shift between a reference waveform and a measured waveform.

FIG. 5 is a waveform diagram illustrating a state in which the phase shift between a reference waveform and a measured waveform is eliminated.

FIG. 6 is a schematic diagram illustrating a schematic configuration of a polarizing axis detection device according to Embodiment 2.

FIG. 7 illustrates an exemplary amount of transmitted light measured by the polarizing axis detection device according to Embodiment 2.

FIG. 8 illustrates a schematic configuration of a polarizing axis detection device according to a modification example.

### MODE FOR CARRYING OUT THE INVENTION

A polarizing axis detection device according to a first configuration of the present invention is characterized by including:

an irradiation part configured to emit sensor light;

a stage on which a polarizing plate is mounted and that rotates;

a light receiving part configured to receive sensor light that has been transmitted through the polarizing plate on the stage, and outputs a signal according to amount of light received; and

an arithmetic part configured to detect orientation of a polarizing axis of the polarizing plate based on the output signal from the light receiving part,

wherein reference data based on an output signal from the light receiving part in a state in which a polarizing plate is arranged with a polarizing axis of the polarizing plate being directed in a desired direction are stored preliminarily in a storage part accessible form the arithmetic part, and

sensor light is projected to a polarizing plate on the stage while the stage is being rotated, and the arithmetic part detects orientation of a polarizing axis of the polarizing plate on the stage, based on a signal output from the light receiving part and the reference data stored in the storage part.

With this configuration, sensor light is projected to a polarizing plate on the stage while the stage is being rotated, and the orientation of the polarizing axis of the polarizing plate on the stage can be detected based on a signal output from the light receiving part and the reference data stored in the storage part. This makes it possible to easily detect the orientation of the polarizing axis, irrespective of the shape of the polarizing plate.

A polarizing axis detection device according to the second configuration of the present invention is the polarizing axis detection device according to the first configuration further characterized in that:

the arithmetic part compares a degree of an angle of rotation of the stage when the signal output from the light receiving part exhibits a peak value, and a degree of an angle of rotation of the stage when the reference data exhibit a peak value, in order to detect orientation of the polarizing axis of the polarizing plate on the stage.

A polarizing axis detection device according to the third configuration is the polarizing axis detection device according to the first configuration further characterized in that

a value of an output signal from the light receiving part in a state in which the polarizing plate is arranged in such a manner that the polarizing axis thereof is directed in a desired direction is stored as the reference data; and

the arithmetic part compares the value of the signal output from the light receiving part, and the value of the reference data, in order to detect orientation of the polarizing axis of the polarizing plate on the stage.

A polarizing axis detection device according to the fourth configuration of the present invention is the polarizing axis detection device according to any one of the first to third configurations further characterized in that two pairs of the irradiation part and the light receiving part are provided.

Further, a method for detecting a polarizing axis of a polarizing plate according to the present invention is a method using a polarizing axis detection device that includes:

an irradiation part configured to emit sensor light;

a stage on which a polarizing plate is mounted and that rotates;

a light receiving part configured to receive sensor light that has been transmitted through the polarizing plate on the stage, and outputs a signal according to amount of light received; and

an arithmetic part configured to detect orientation of a polarizing axis of the polarizing plate based on the output signal from the light receiving part, and

the method includes:

preliminarily storing reference data based on an output signal from the light receiving part in a state in which a polarizing plate is arranged with a polarizing axis of the polarizing plate being directed in a desired direction, in a storage part accessible form the arithmetic part; and

projecting sensor light to a polarizing plate on the stage while the stage is being rotated, and detecting, with use of the arithmetic part, orientation of a polarizing axis of the polarizing plate on the stage, based on a signal output from the light receiving part and the reference data stored in the storage part.

Further, a method for producing a display device according to the present invention is a method for producing a display device that includes a polarizing plate, and the method includes:

detecting orientation of a polarizing axis of a polarizing plate by the above-described method for detecting a polarizing axis; and

attaching the polarizing plate and a display panel.

It is preferable that the above-described display panel is, for example, a liquid crystal panel or an organic EL panel.

### EMBODIMENT

The following description describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of a part of constituent members is omitted. Further, the dimension ratios of the constituent members illustrated in the drawings do not necessarily indicate the real dimension ratios.

### Embodiment 1

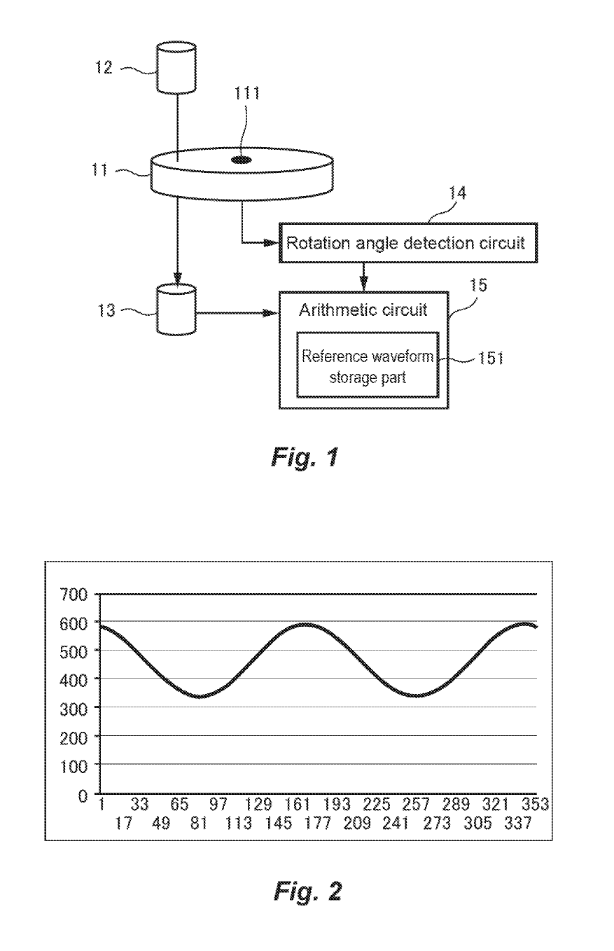

FIG. 1 is a schematic diagram illustrating a schematic configuration of a polarizing axis detection device according to Embodiment 1. The polarizing axis detection device according to the present embodiment is used in a polarizing axis detection step performed in a stage prior to a step of attaching a polarizing plate to a display panel such as a liquid crystal panel or an EL panel in a manufacturing line. The direction of the polarizing axis of the polarizing plate is detected accurately by this polarizing axis detection device, and the orientation of the polarizing plate is corrected so that the direction of the polarizing axis thereof is oriented to a desired direction (a direction as designed). Thereafter, a display panel as an object to which the polarizing plate is to be attached is supplied to the polarizing plate in such a manner that the position thereof is aligned, and the polarizing plate and the display panel are attached to each other.

As illustrated in FIG. 1, a polarizing axis detection device 1 of the present embodiment includes a stage 11 on which a polarizing plate as a detection object is to be mounted, optical sensors (an irradiation head 12 and a light receiving head 13), a rotation angle detection circuit 14, and an arithmetic circuit 15. Here, in the present embodiment, the polarizing plate as a detection object is assumed to be a round plate shape, and the stage 11 is also assumed to be a round plate shape.

The stage 11 is formed so as to rotate around the rotation axis 111. The stage 11 is made of a material that transmits light emitted from the irradiation head 12 therethrough. When the stage 11 rotates, the rotation angle detection circuit 14 detects a predetermined angle reference position, or a degree of an angle of rotation from the rotation start position. The detected degree of the angle of rotation is output to the arithmetic circuit 15.

The irradiation head 12 incorporates a laser beam source (not shown), and projects laser light toward the light receiving head 13. This laser light has a wavelength in a visible light range (400 nm to 700 nm). Light having a wavelength outside the visible light range (infrared light, or the like), however, can be used as detection light, as long as the amount of transmitted light from the polarizing plate exhibits changes as the stage 11 rotates.

The irradiation head 12 and the light receiving head 13 may be configured as a fiber sensor.

The light receiving head 13 receives light that was emitted from the irradiation head 12 and was transmitted through the polarizing plate on the stage 11, and outputs a signal indicative of the amount of the light to the arithmetic circuit 15. The polarizing axis detection device 1 according to the present embodiment projects light from the irradiation head 12 while rotating the stage 11, and detects a change in the signal output from the light receiving head 13. The arithmetic circuit 15 detects the orientation of the polarizing axis of the polarizing plate on the stage 11, based on the change in the output signal that occurs along with the rotation.

It is desired that, when the polarizing plate as the detection object is mounted on the stage 11, the center of the polarizing plate and the center of the rotation axis 111 of the stage 11 coincide with each other. Besides, it is preferable that the position irradiated with light from the irradiation head 12 is farther from the rotation axis 111 of the stage 11 in the radial direction. The rotation of the stage 11 is commonly controlled by a motor or the like. This is for the following reason: in a case where the rotation angle (step angle) per one pulse of the motor is reduced, the irradiation head 12 may be provided in such a manner that the position at which light therefrom is projected is farther in the radial direction from the rotation axis 111 of the stage 11 in order to achieve results of detection at a higher resolution. This causes a change in the amount of light per step angle unit to increase, thereby making the detection easier.

The following description describes a method for detecting the orientation of the polarizing axis with use of the polarizing axis detection device 1.

Prior to the actual detection, a polarizing plate is mounted on the stage 11 in such a manner that the direction of the polarizing axis is directed as designed, and a waveform of an output signal from the light receiving head 13 is obtained as a reference waveform. It is assumed that, for example, a reference waveform as illustrated in FIG. 2 is obtained. In the waveform diagram of FIG. 2, the horizontal axis represents the degree of angle of rotation of the stage 11 from a certain reference position, and the vertical axis represents the amount of transmitted light. Data of such a reference waveform are stored in a reference waveform storage part 151 inside the arithmetic circuit 15. The data of the reference waveform, however, may be stored in an external memory (not shown) accessible from the arithmetic circuit 15, instead of the inside of the arithmetic circuit 15.

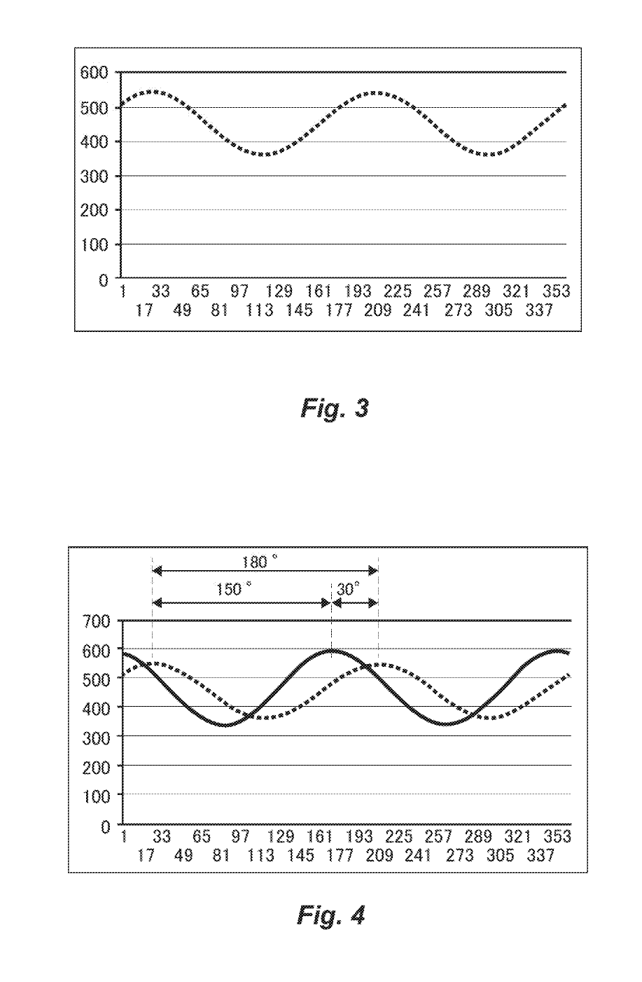

Next, a polarizing plate as a detection object is mounted on the stage 11. Here, the orientation of the polarizing plate may be random. Then, light is projected from the irradiation head 12 while the stage 11 is rotated, and changes in the signal output from the light receiving head 13 are detected. Here, it is assumed that a waveform as illustrated in FIG. 3 is obtained. As is clear from FIGS. 2 and 3, both of the reference waveform in FIG. 2 and a measured waveform in FIG. 3 are sinusoidal waves, but have a phase shift therebetween.

Then, as illustrated in FIG. 4, a phase shift between the reference waveform and the measured waveform is detect by using respective peak values (respective maximum values or respective minimum values of the amounts of light) of the reference waveform and the measured waveform. From the detection results obtained, a shift angle between the orientation of the polarizing axis when the reference waveform is obtained, and the orientation of the polarizing axis when the waveform is measured, can be determined. As described above, the waveform of the amount of the transmitted light is a sinusoidal wave, and four peak values exist in the range of the angle of rotation from 0° to 360°. The peak value therefore can be detected when the stage 11 is rotated by at least 90°, which means that it is not necessary to rotate the stage 11 by 360°.

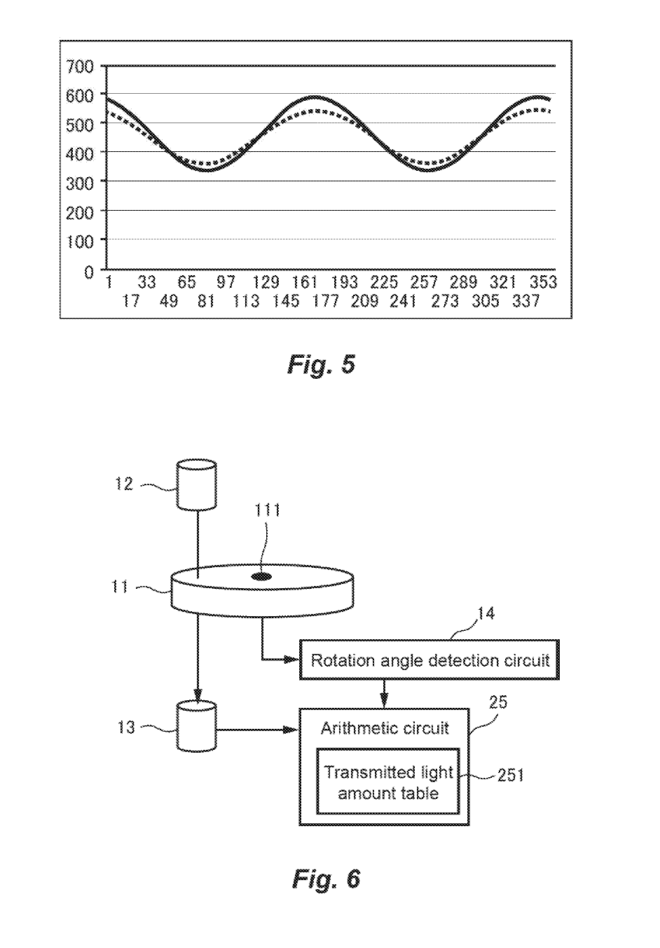

The polarizing plate therefore may be rotated by the shift angle of the polarizing axis thus determined, whereby the polarizing plate can be attached to the liquid crystal panel or the like in a state in which the orientation of the polarizing axis is adjusted to the angle as designed (see FIG. 5). For example, in a case where a shift between the peak position of the reference waveform and the peak position of the measured waveform is 30° as Illustrated in FIG. 4, the orientation of the polarizing plate may be rotated by only 150° or 30° by rotating the stage 11, whereby the shift with respect to the orientation of the polarizing axis when the reference waveform is obtained (the orientation of the polarizing axis as designed) can be eliminated.

Then, to the polarizing plate on the stage 11 in a state in which the shift with respect to the orientation of the polarizing axis as designed is eliminated in this way, a liquid crystal panel or the like as an object to which the polarizing plate is to be attached is aligned, and it is attached.

In the present embodiment, the polarizing axis is detected, and thereafter, a panel is supplied onto the polarizing axis detection device, and the attaching operation is performed. The operation of correcting a shift angle of the polarizing axis (the operation of rotating the polarizing plate), however, may be performed during a conveyance operation between the polarizing axis detection step and the attaching step, or may be performed during the attaching step.

In a case where a pair of polarizing plates (a polarizer and an analyzer) are attached to both surfaces of a panel, respectively, as is the case with a liquid crystal panel, the configuration may be as follows: respective reference waveforms are individually determined for the polarizer and the analyzer, and the orientation of the polarizing axis of the polarizer and the orientation of the polarizing axis of the analyzer are individually determined by comparing the same with the respective reference waveforms.

With the polarizing axis detection device 1 according to the present embodiment, the direction of the polarizing axis of a polarizing plate, not only in a round plate shape, but also in a rectangular shape or another arbitrary shape, can be detected. FIG. 1 illustrates an example in which the stage 11 is in a round plate shape, but the shape of the stage is arbitrary. Further, the shape of the stage and the shape of the polarizing plate as the detection object are not necessarily identical to each other. As described above, preferably, the center of rotation of the stage and the center position of the polarizing plate coincide with each other.

### Embodiment 2

A polarizing axis detection device according to Embodiment 2 of the present invention has a schematic configuration identical to that of the polarizing axis detection device 1 of Embodiment 1 described above. The processing operation in the arithmetic circuit, however, is different from that in Embodiment 1, and an arithmetic circuit 25 is included in place of the arithmetic circuit 15 according to Embodiment 1.

The arithmetic circuit 25 includes a transmitted light amount table 251. The amount of transmitted light in a case where a polarizing plate is arranged on the stage 11 so that the polarizing axis is directed in an orientation as designed is measured preliminarily, and is recorded in the transmitted light amount table 251. If the polarizing plate is attached to a panel so that the polarizing axis thereof is directed in the designed orientation, the panel has the maximum contrast. Therefore, a panel for test is prepared, and while the attachment orientation of the polarizing plate is being adjusted, the orientation of the polarizing axis when the contrast is maximized is determined. Then, in a state in which only the polarizing plate is arranged on the stage 11 while the orientation of the polarizing axis is maintained, light is projected from the irradiation head 12, and the amount of the light received at the light receiving head 13 is detected. The value of the amount of received light detected therein is stored in the transmitted light amount table 251. In other words, the value of the amount of received light stored here is the amount of transmitted light when the orientation of the polarizing axis of the polarizing plate is optimized.

Then, the polarizing plate as a detection object is mounted on the stage 11. Here, the orientation of the polarizing plate may be random. Next, light is projected from the irradiation head 12 while the stage 11 is being rotated, signals output from the light receiving head 13 (the amount of transmitted light) are detected. The arithmetic circuit 25 compares the detected amount of transmitted light with the amount of transmitted light stored in the transmitted light amount table 251, and detects the degree of an angle of rotation at which the difference therebetween is minimized.

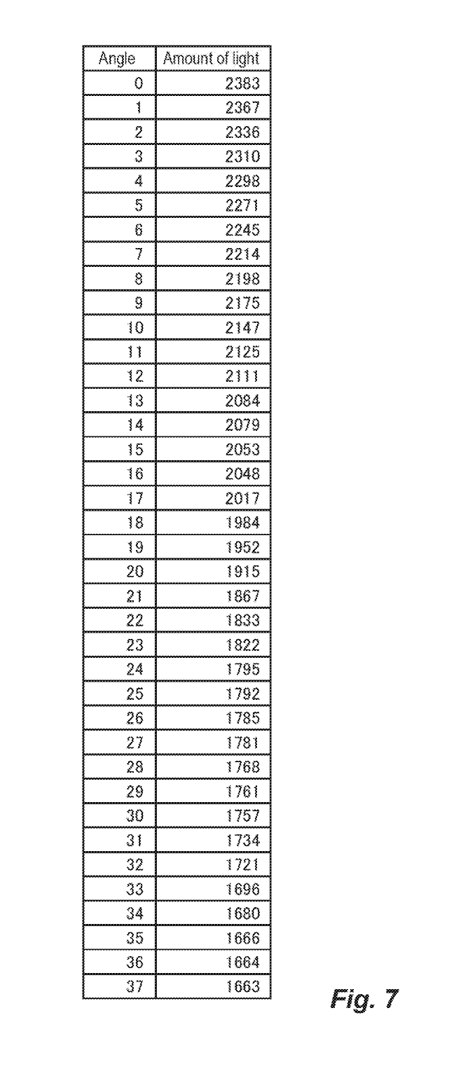

For example, the amount of transmitted light stored in the transmitted light amount table 251 is assumed to be 1952, and the amount of transmitted light output from the light receiving head 13 to the arithmetic circuit 25 is as illustrated in FIG. 7. In this case, since the amount of transmitted light when the degree of the angle of rotation is 19° is 1952, a polarizing plate may be supplied to the attaching step while the state in the case where the degree of the angle of rotation of the stage 11 is 19° is being maintained. This makes it possible to attach the polarizing plate to a liquid crystal panel or the like in a state in which the orientation of the polarizing axis is adjusted at an angle as designed.

The data of the amount of transmitted light stored in the transmitted light amount table 251, however, are not limited to data regarding one point. For example, the transmitted light amount table 251 may be caused to store the amount of transmitted light when the contrast is maximized on a panel for test and data around the same.

Further, data of the amount of transmitted light when the contrast is minimized may be used, in place of the amount of transmitted light when the contrast is maximized.

### Modification Example

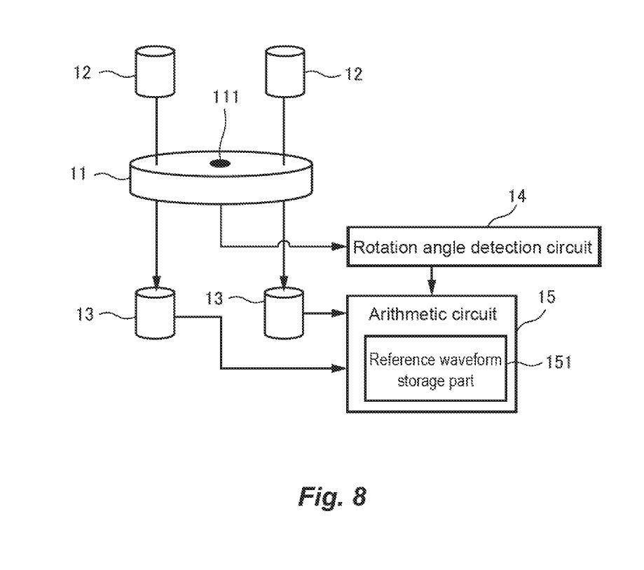

The foregoing embodiment is described with reference to an exemplary configuration that includes a pair of the irradiation head 12 and the light receiving head 13, but the configuration may be, for example, such a configuration that includes two pairs of the irradiation head 12 and the light receiving head 13, as illustrated in FIG. 8. In a case of such a configuration that includes two pairs of the irradiation head and the light receiving head, data obtained by one of the pairs of sensors (the irradiation head and the light receiving head) can be checked by the other pair of sensors regarding whether or not the data contain any error and the like. For example, the foregoing configuration has the following advantage: in a case where the center of rotation of the stage 11 and the center of the polarizing plate as a measurement object do not completely coincide with each other, the direction of the polarizing axis can be detected more accurately by using two pairs of the sensors. The positional relationship between the two pairs of the sensors is not particularly limited.

FIG. 8 illustrates an exemplary configuration obtained by adding one more pair of sensors to the configuration according to Embodiment 1 illustrated in FIG. 1. It is, however, also possible that two pairs of sensors are used in the configuration according to Embodiment 2.

The above-described embodiment is merely an example for implementing the present invention. The present invention, therefore, is not limited to the above-described embodiment, and the above-described embodiment can be appropriately varied and implemented without departing from the spirit and scope of the invention.

### DESCRIPTION OF REFERENCE NUMERALS

1: polarizing axis detection device
11: stage
111: center of rotation
12: irradiation head
13: light receiving head
14: rotation angle detection circuit
15: arithmetic circuit
151: reference waveform storage part
25: arithmetic circuit
251: transmitted light amount table

1. A polarizing axis detection device comprising:
an irradiation part configured to emit sensor light;
a stage on which a polarizing plate is mounted and that rotates;
a light receiving part configured to receive sensor light that has been transmitted through the polarizing plate on the stage, and outputs a signal according to amount of light received; and
an arithmetic part configured to detect orientation of a polarizing axis of the polarizing plate based on the output signal from the light receiving part,
wherein reference data based on an output signal from the light receiving part in a state in which a polarizing plate is arranged with a polarizing axis of the polarizing plate being directed in a desired direction are stored preliminarily in a storage part accessible form the arithmetic part, and
sensor light is projected to a polarizing plate on the stage while the stage is being rotated, and the arithmetic part detects orientation of a polarizing axis of the polarizing plate on the stage, based on a signal output from the light receiving part and the reference data stored in the storage part.

2. The polarizing axis detection device according to claim 1,
wherein the arithmetic part compares a degree of an angle of rotation of the stage when the signal output from the light receiving part exhibits a peak value, and a degree of an angle of rotation of the stage when the reference data exhibit a peak value, in order to detect orientation of the polarizing axis of the polarizing plate on the stage.

3. The polarizing axis detection device according to claim 1,
wherein a value of an output signal from the light receiving part in a state in which the polarizing plate is arranged in such a manner that the polarizing axis thereof is directed in a desired direction is stored as the reference data, and
the arithmetic part compares the value of the signal output from the light receiving part, and the value of the reference data, in order to detect orientation of the polarizing axis of the polarizing plate on the stage.

4. The polarizing axis detection device according to claim 1,
wherein two pairs of the irradiation part and the light receiving part are provided.

5. A method for detecting a polarizing axis, using a polarizing axis detection device that includes:
an irradiation part configured to emit sensor light;
a stage on which a polarizing plate is mounted and that rotates;
a light receiving part configured to receive sensor light that has been transmitted through the polarizing plate on the stage, and outputs a signal according to amount of light received; and
an arithmetic part configured to detect orientation of a polarizing axis of the polarizing plate based on the output signal from the light receiving part,
the method comprising:
preliminarily storing reference data based on an output signal from the light receiving part in a state in which a polarizing plate is arranged with a polarizing axis of the polarizing plate being directed in a desired direction, in a storage part accessible form the arithmetic part; and
projecting sensor light to a polarizing plate on the stage while the stage is being rotated, and detecting, with use of the arithmetic part, orientation of a polarizing axis of the polarizing plate on the stage, based on a signal output from the light receiving part and the reference data stored in the storage part.

6. A method for producing a display device that includes a polarizing plate, the method comprising:
detecting orientation of a polarizing axis of a polarizing plate by the method for detecting a polarizing axis according to claim 5; and
attaching the polarizing plate and a display panel.

7. A display device produced by the method for producing a display device according to claim 6.

8. The display device according to claim 7,
wherein the display panel is a liquid crystal panel or an organic EL panel.
